(19) United States
(12) Patent Application Publication
(10) Pub. No.: US 2026/0194966 A1
(43) Pub. Date: Jul. 9, 2026

(54) AN EXTENDED-REALITY INTERACTION SYSTEM

(71) Applicant: FLATFROG LABORATORIES AB, Lund (SE)

(72) Inventors: Mattias KRUS, Lund (SE); Tomas CHRISTIANSSON, Torna-Hällestad (SE)

(21) Appl. No.: 18/868,077

(22) PCT Filed: May 10, 2023
(86) PCT No.: PCT/SE2023/050456

§ 371 Date: Nov. 21, 2024

(30) Foreign Application Priority Data
May 31, 2022 (SE) 2230169-1

(51) Int. Cl. G06F 3/01; G06F 3/041; G06F 3/042

(52) U.S. Cl. CPC G06F 3/011; G06F 3/04162; G06F 3/04166; G06F 3/0418; G06F 3/0425; G06F 2203/04101

(57) ABSTRACT

An interaction system is disclosed comprising a positioning unit configured to provide spatial position information of the position of an interaction surface relative to a user, and of the position of an input object relative to the interaction surface, a contact with the interaction surface is detected as a contact event, a processing unit configured to map the spatial position information of the interaction surface and the input object to the XR environment coordinate system, generate a virtual representation of the input motion in the XR environment coordinate system while the contact event is detected, communicate a set of XR environment coordinates of the interaction surface and of the virtual representation of the input motion to an XR output device so that the interaction surface is displayed as a virtual user surface within a virtual space together with the virtual representation of the input motion.

### TECHNICAL FIELD

The present disclosure relates generally to the field of extended-reality (XR) interaction systems. More particularly, the present disclosure relates to an interaction system with an interaction surface for an input object and a touch-based XR interaction system, and related methods.

### BACKGROUND

To an increasing extent, touch-sensitive panels are being used for providing input data to computers, gaming devices, presentation-and conference systems etc. Alongside this development is the growing field of Extended reality (XR) systems and applications. XR presents the user with an environment partially if not fully disconnected from the actual physical environment of the user. XR is a term that refers to any environment that is a combination of real and virtual elements, as well as any human-machine interactions that are generated by computer technology and wearables. This can include forms of augmented reality (AR), mixed reality (MR), and virtual reality (VR), as well as any areas in between these forms. Various ways of interacting with this environment have been tried. These include IR tracked gloves, IR tracked wands or other gesturing tools, gyroscope-/accelerometer tracked objects. The IR tracked objects are typically tracked using one or more IR sensors configured to view and triangulate IR light sources on the IR tracked objects. Such interaction systems provide high latency, low accuracy user input to the virtual environment and lack of feedback to the user. It would thus be advantageous to provide a XR interaction system with a high-precision interface and a more natural interaction experience for the user.

### SUMMARY

It is an objective of the disclosure to at least partly overcome one or more of the above-identified limitations of the prior art.

One objective is to provide an interaction system with a more natural feedback and XR interaction experience for the user.

One objective is to provide an XR interaction system with a high-precision interface.

Another objective is to provide for an XR interaction system in which a user interacts with an interaction surface in the physical reality whilst viewing the interaction in the extended reality.

Another objective is to provide a touch-based XR interaction system in which a user interacts with a high precision touch sensitive apparatus in the physical reality whilst viewing the interaction in the extended reality.

One or more of these objectives, and other objectives that may appear from the description below, are at least partly achieved by means of an interaction system and a touch-based interaction system, and related methods according to the independent claims, embodiments thereof being defined by the dependent claims.

According to a first aspect an interaction system is provided comprising an interaction surface to be engaged by a user by providing an input object in contact with the interaction surface for an input motion thereon, a XR output device configured to display a model of the user in a XR environment coordinate system (vₓ, v_{y}, v_{z}) within a virtual space, a positioning unit configured to provide spatial position information of the position of the interaction surface (x, y, z) relative to the user, and of the position of the input object (xᵤ, yᵤ, zᵤ) relative to the interaction surface, wherein the contact with the interaction surface is detected as a contact event, a processing unit in communication with the positioning unit and being configured to map the spatial position information of the interaction surface and the input object to the XR environment coordinate system, generate a virtual representation of the input motion in the XR environment coordinate system while the contact event is detected, and communicate a set of XR environment coordinates of the interaction surface and of the virtual representation of the input motion to the XR output device so that the interaction surface is displayed as a virtual user surface within the virtual space together with the virtual representation of the input motion by the input object.

According to a second aspect a method in an interaction system is provided, the interaction system having an interaction surface to be engaged by a user by providing an input object in contact with the interaction surface for an input motion thereon, and an XR output device configured to display a model of the user in a XR environment coordinate system (vₓ, v_{y}, v_{z}) within a virtual space, the method comprising providing spatial position information of the position of the interaction surface (x, y, z) relative to the user and of the position of the input object (xᵤ, yᵤ, zᵤ) relative to the interaction surface, wherein the contact with the interaction surface is detected as a contact event, mapping the spatial position information of the interaction surface and the input object to the XR environment coordinate system, generating a virtual representation of the input motion in the XR environment coordinate system while the contact event is detected, communicating a set of XR environment coordinates of the interaction surface and of the virtual representation of the input motion to the XR output device so that the interaction surface is displayed as a virtual user surface within the virtual space together with the virtual representation of the input motion by the input object.

According to a third aspect an interaction system is provided comprising a touch sensitive apparatus configured to receive touch input from a user, a XR output device configured to display a position of the user and a virtual representation of the touch input in a XR environment coordinate system within a virtual space, a positioning unit configured to provide spatial position information of the position of the touch sensitive apparatus relative to the user, and a processing unit configured to map the spatial position information of the touch sensitive apparatus to the XR environment coordinate system. The processing unit is configured to communicate a set of XR environment coordinates of the touch sensitive apparatus to the XR output device so that the touch sensitive apparatus is displayed within the virtual space together with the virtual representation of the touch input.

According to a fourth aspect a method in an interaction system is provided. The system having a touch sensitive apparatus configured to receive touch input from a user, and a XR output device configured to display a position of the user and a virtual representation of the touch input in a XR environment coordinate system within a virtual space. The method comprises providing spatial information of the position of the touch sensitive apparatus relative to the user, mapping the spatial position information of the touch sensitive apparatus to the XR environment coordinate system, and communicating a set of XR environment coordinates of the touch sensitive apparatus to the XR output device so that the touch sensitive apparatus is displayed within the virtual space together with the virtual representation of the touch input.

According to a fifth aspect a computer program product is provided comprising instructions which, when the program is executed by a computer, cause the computer to carry out the steps of the method according to the second aspect.

According to a sixth aspect a computer program product is provided comprising instructions which, when the program is executed by a computer, cause the computer to carry out the steps of the method according to the fourth aspect.

Further examples of the disclosure are defined in the dependent claims, wherein features for the first aspect may be implemented for the second and subsequent aspects, and vice versa.

Some examples of the disclosure provide for a XR interaction system with a more intuitive and natural user feedback.

Some examples of the disclosure provide for an XR interaction system in which a user interacts with an interaction surface in the physical reality whilst viewing the interaction in the extended reality.

Some examples of the disclosure provide for a XR interaction system with a high-precision interface.

Some examples of the disclosure provide for a touch-based XR interaction system in which a user interact with a high precision touch sensitive apparatus in the physical reality whilst viewing the interaction in the extended reality.

Some examples of the disclosure provide for an enhanced XR experience via interaction with a touch panel.

Some examples of the disclosure provide for capturing input from a user's interaction with a XR environment with a high accuracy.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which examples of the disclosure are capable of will be apparent and elucidated from the following description of examples of the present disclosure, reference being made to the accompanying schematic drawings, in which;

FIG. 1 shows a touch-based extended-reality (XR) interaction system according to examples of the disclosure;

FIG. 2 shows a touch-based XR interaction system according to examples of the disclosure;

FIG. 3 shows a touch-based XR interaction system according to examples of the disclosure;

FIG. 4 shows a touch-based XR interaction system according to examples of the disclosure;

FIG. 5 shows a touch-based XR interaction system according to examples of the disclosure;

FIG. 6 shows a touch-based XR interaction system according to examples of the disclosure;

FIG. 7 shows a touch-based XR interaction system according to examples of the disclosure;

FIG. 8 shows a touch-based XR interaction system according to examples of the disclosure;

FIG. 9 shows a touch-based XR interaction system according to examples of the disclosure;

FIG. 10 shows a XR environment in which a plurality of virtual representations of a touch sensitive apparatus is shown, according to examples of the disclosure;

FIG. 11 is a flowchart of a method in a touch-based XR interaction system according to examples of the disclosure;

FIGS. 12a-b show XR interaction systems according to examples of the disclosure;

FIG. 13 shows an XR interaction system according to an example of the disclosure;

FIGS. 14a-c show XR interaction systems according to examples of the disclosure; and

FIG. 15 is a flowchart of a method in an XR interaction system according to examples of the disclosure.

### DETAILED DESCRIPTION

Specific examples of the disclosure will now be described with reference to the accompanying drawings. This disclosure may, however, be embodied in many different forms and should not be construed as limited to the examples set forth herein; rather, these examples are provided so that this disclosure will be thorough and complete, and will fully convey the scope of the disclosure to those skilled in the art. The terminology used in the detailed description of the examples illustrated in the accompanying drawings is not intended to be limiting of the disclosure. In the drawings, like numbers refer to like elements.

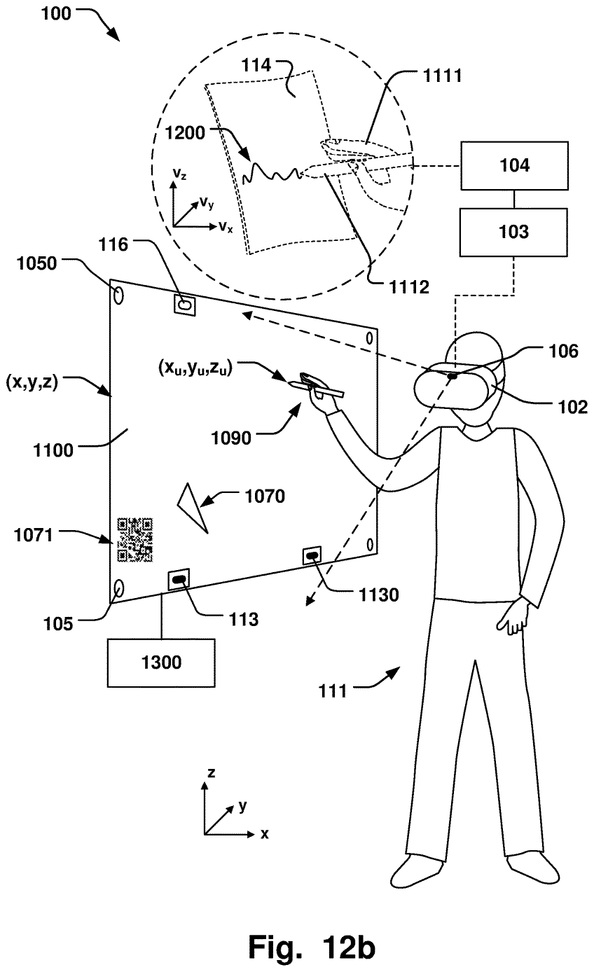

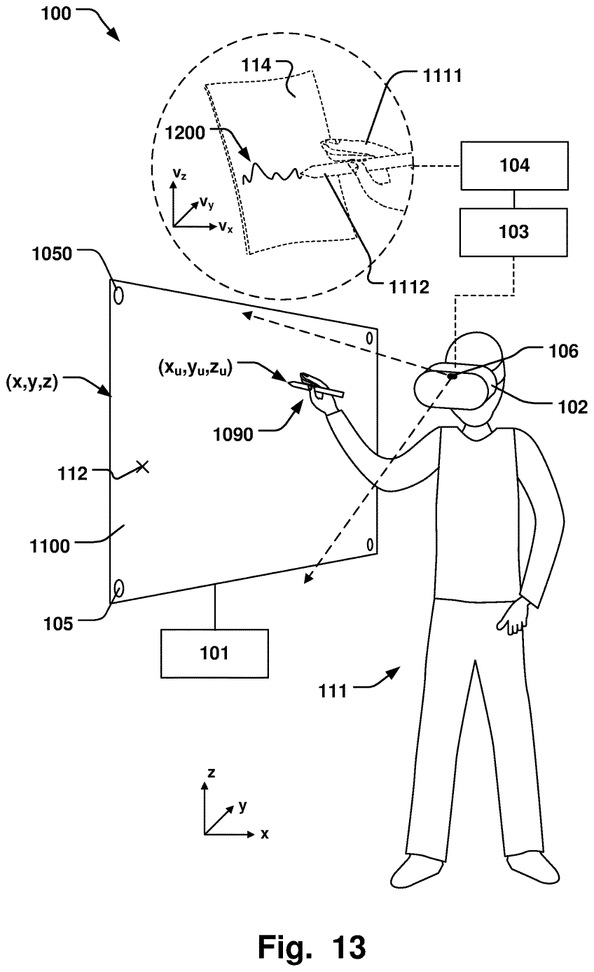

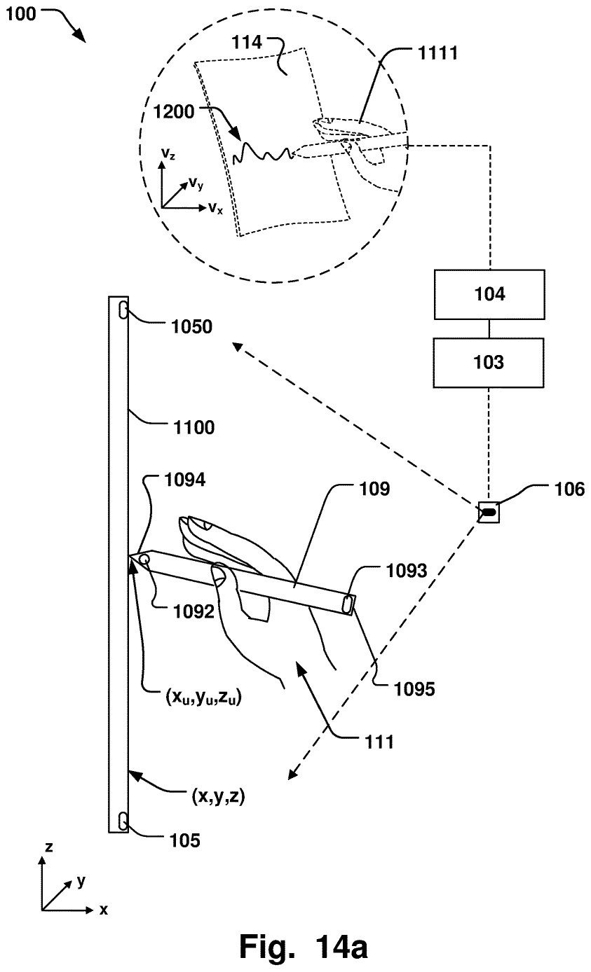

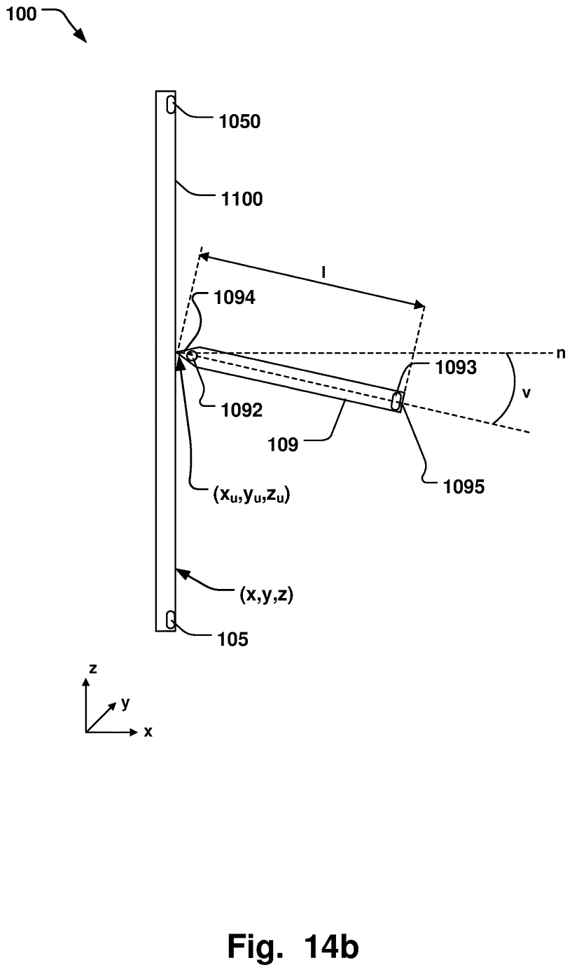

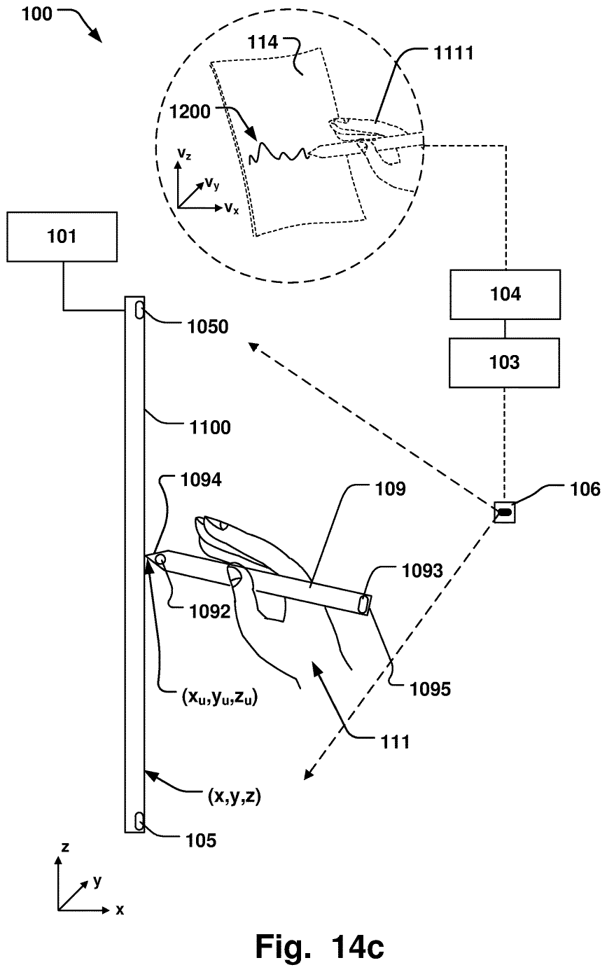

FIG. 12a is a schematic illustration of an interaction system 100 comprising an interaction surface 1100 to be engaged by a user 111 by providing an input object 1090 in contact with the interaction surface 1100. The user 111 may thus move the input object 1090 with an input motion on the interaction surface 1100. The input object 1090 may be a user input device 109 (see e.g. FIG. 14a), such as a stylus, or a user's hand or finger. The interaction system 100 comprises a XR output device 102 configured to display a model 1111 of the user 111 in a XR environment coordinate system (vₓ, v_{y}, v_{z}) within a virtual space, as schematically indicated in FIG. 12a. XR output device 102 may also be configured to display a virtual representation of the input object 1090 in the virtual space, such as a virtual input device 1112 representing the user input device 109. The XR output device 102 may be configured to be wearable by the user 111 and may thus comprise a XR headset.

The interaction system 100 comprises a positioning unit 103 configured to provide spatial position information of the position of the interaction surface 1100, indicated in FIG. 12a as having coordinates (x, y, z), relative to the user 111. The positioning unit 103 is further configured to provide spatial position information of the position of the input object 1090, having coordinates (xᵤ, yᵤ, zᵤ), relative to the interaction surface 1100. The positioning unit 103 may be configured to determine the position of the input object 1090 relative to the interaction surface 1100 over a duration of time, during which the user 111 interacts with the interaction surface 1100. The positioning unit 103 may thus be configured to determine when the user 111 brings the input object 1090 in contact with the interaction surface 1100. Bringing the input object 1090 in contact with the interaction surface 1100 is detected and determined as a contact event.

The interaction system 100 comprises a processing unit 104 in communication with the positioning unit 103. The processing unit 104 is configured to map the spatial position information of the interaction surface 1100 and the input object 1090 to the XR environment coordinate system (vₓ, v_{y}, v_{z}). The processing unit 104 is configured to generate a virtual representation 1200 of the input motion in the XR environment coordinate system (vₓ, v_{y}, v_{z}) while the contact event is detected, i.e. while the user 111 has placed the input device 1090 in contact with the interaction surface 1100. The processing unit 104 is configured to communicate a set of XR environment coordinates of the interaction surface 1100 and of the virtual representation 1200 of the input motion to the XR output device 102 so that the interaction surface 1100 is displayed as a virtual user surface 114 within the virtual space together with the virtual representation 1200 of the input motion by the input object 1090. FIG. 12a shows an example where the virtual representation 1200 of the input motion is displayed in relation to a virtual user surface 114 within the virtual space. The user 111 may thus interact with a physical surface, i.e. the interaction surface 1100, while observing the interaction in the virtual space, e.g. by observing the virtual representation 1200 of the input motion. This provides the user 111 with a natural interaction experience, where the muscle memory of interacting with a physical surface, such as when writing or drawing, is combined with the freedom of interacting with the virtual space. This solves the problem with previous solutions where the user 111 has to try provide input into the XR applications by waving a controller or the hands in the air. Such mode of control input is less precise and will be fatiguing to the user as the XR applications become more complex and requiring precise input. The interaction system 100 thus provides for an XR experience which allows for more precise and natural input, which will be less fatiguing to the user.

The XR user may thus reliably interact with a high precision with the interaction surface 1100 in the physical reality whilst viewing the interaction in XR. Mapping the position of the interaction surface 1100 to the XR environment provides for an enhanced XR experience combining the freedom of customizing different XR environments to the user's tasks with the tactile interaction provided by the interaction surface 1100. A more practical utilization of XR may thus be provided, across a range of applications and technical fields.

The interaction system 100 may comprise at least one spatial marker 105, 1050, arranged on the interaction surface 1100, as schematically illustrated in e.g. FIGS. 12a, 13 and 14a. The positioning unit 103 may be configured to track the at least one spatial marker 105, 1050, to determine an associated position of the interaction surface 1100 relative to the user. The at least one spatial marker 105, 1050, may comprise IR markers such as IR light sources, or any other marker configured for allowing tracking by the positioning unit 103, such as markers of different shapes and configurations being physically provided on parts of the interaction surface 1100 and/or displayed on the interaction surface 1100. The interaction surface 1100 may in the latter case be arranged over a display or light source configured to display the at least one spatial marker 105, 1050. The interaction surface 1100 may thus be light transmissive. Accurate mapping of the obtained spatial position information to the XR environment coordinate system may then be provided. FIG. 12a illustrates first and second spatial markers 105, 1050, but it is conceivable that the number of spatial markers may be varied to provide for an optimized position detection.

The interaction system 100 may comprise an image sensor device 106 configured to be wearable by the user, as schematically illustrated in FIG. 12-13. The image sensor device 106 may thus be arranged in the XR output device 102. The image sensor device 106 may be configured to capture image data 107, 1070, 1071, 1072, associated with the position of the interaction surface 1100 and communicate the image data to the positioning unit 103, which is configured to determine the position of the interaction surface 1100 relative to the user 111 based on the captured image data, such as by a triangulation process of the obtained image data. The positioning unit 103 may also be arranged in the XR output device 102, and may thus be directly connected to, or integrated with, the image sensor device 106.

Since the image sensor device 106 may be arranged at the position of the user 111, i.e. by being wearable, the relative position between the user 111 and the interaction surface 1100 may be accurately determined. This provides for accurately determining the XR environment coordinates of the interaction surface 1100 and a precise positioning the interaction surface 1100 in the virtual space. Such precise positioning in the virtual space facilitates the user interaction when the user is immersed in the XR experience, since the virtual user surface 114 may be precisely aligned with the physical interaction surface 1100. The interaction system 100 thus enables high-resolution input and for more complex tasks to be carried out by the user in the XR space.

The image sensor device 106 may be configured to capture image data of the at least one spatial marker 105, 1050, and communicate the image data to the positioning unit 103, which is configured to determine the position of the interaction surface 1100 relative to the user 111 based on the captured image data. FIG. 12a illustrates an example where the image sensor device 106 locates the position of the interaction surface 1100 based on spatial markers 105, 1050. The processing unit 104 may then accurately map the retrieved spatial position information to the XR environment coordinate system.

The interaction surface 1100 may be configured as a display device. The interaction surface 1100 may in one example be configured to be arranged over a display device. The image sensor device 106 may be configured to capture image data 1070 displayed by the interaction surface 1100 and communicate the image data to the positioning unit 103, as schematically illustrated in FIG. 12b. The image data 1070 displayed by the interaction surface 1100 may comprise objects of varying shapes and configurations that allow for a calibration of the position of the interaction surface 1100 in the XR environment coordinate system. A flexible and highly optimizable calibration may thus be provided since the displayed image data may be varied for different conditions and applications.

The interaction surface 1100, or a display over which the interaction surface 1100 is arranged, may be configured to display image data comprising at least one orientation tag 1071, as schematically illustrated in FIG. 12b. The positioning unit 103 may be configured to track the position of the at least one orientation tag 1071 to determine an associated position of the interaction surface 1100 relative to the user 111. The number of orientation tags 1071 displayed and the configurations thereof may vary to provide for a precise positioning procedure and a XR environment which is accurately anchored to the physical reality, i.e. the interaction surface 1100.

The interaction system 100 may comprise a light emitter 116 arranged at a determined spatial position relative to the interaction surface 1100, as schematically illustrated in FIG. 12b. The image sensor device 106 may be configured to capture image data of light emitted by the light emitter 116 and communicate the image data to the positioning unit 103, which may be configured to determine the position of the interaction surface 1100 relative to the user 111 based on the captured image data. The light may be IR light or light of any other wavelength suitable for detection by the image sensor device 106.

The image sensor device 106 may be arranged at the XR output device 102, as schematically illustrated in FIGS. 12-13. It is conceivable however that the image sensor device 106 may be displaced from the XR output device 102 but at a predetermined distance from the interaction surface 1100 and communicating with the positioning unit 103, so that the different image data discussed above, e.g. 1070, 1071, may be received by the positioning unit 103. The image sensor device 106 may be configured to capture image data of the input object 1090 and communicate said image data to the positioning unit 103. The positioning unit may be configured to determine the position (xᵤ, yᵤ, zᵤ) of the input object 1090 relative to the interaction surface 1100 and an orientation of the input object 1090 relative to the interaction surface 1100 based on the captured image data. The coordinates (xᵤ, yᵤ, zᵤ) describing the position of the input object 1090 may comprise a set of coordinates that defines the input object 1090 in three dimensions (3D). Thus, the orientation of the input object 1090, e.g. of an input device 109, may be determined from the coordinates (xᵤ, yᵤ, zᵤ). A corresponding virtual input device 1112 representing the user input device 109 may thus be accurately determined as a 3D representation in the virtual space. The user 111 may thus be effectively guided to grab the user input device 109 while wearing the XR headset, i.e. the XR output device 102.

The positioning unit 103 may be configured to continuously determine the position (xᵤ, yᵤ, zᵤ) of the input object 1090 relative to the interaction surface 1100 to track a motion of the input object 1090 over a duration of time, and to calculate a velocity and/or an acceleration of the input object 1090.

As mentioned, the input object 1090 may comprise a user input device 109, such as a stylus. The user input device 109 may comprise at least one stylus marker 1092, 1093, as schematically illustrated in FIGS. 14a-c. The positioning unit 103 may be configured to track the at least one stylus marker 1092, 1093, to determine the associated position (xᵤ, yᵤ, zᵤ) of the user input device 109 relative to the interaction surface 1100. The stylus marker 1092, 1093, may be tracked by capturing image data of the same with the image sensor device 106, which may be arranged in the user's XR headset, i.e. XR output device 102.

The user input device 109 may comprise first and second stylus markers 1092, 1093, at opposite ends 1094, 1095, of the user input device 109. FIG. 14a shows an example where a first stylus marker 1092 is arranged at a first end, i.e. the tip 1094 of the stylus being placed against the interaction surface 1100, and a second stylus marker 1093 is arranged at the opposite end 1095, closest to the user's head. This provides for determining the relative positions of the opposite ends 1094, 1095, of the user input device 109, such that an angle (v) of the user input device 109, relative a normal axis (n) of the interaction surface 1100, may be determined (see FIG. 14b). Further, determining the position of the second stylus marker 1093 at the end 1095, opposite the tip 1094, and knowing the length (l) of the user input device 109, allows for determining the position of the tip 1094 based on the determined angle (v). I.e. this provides for determining the coordinate (xᵤ, yᵤ, zᵤ) of the tip 1094 even if it would be obscured by the user 111.

The positioning unit 103 may be configured to detect when the user 111 places the input object 1090 in contact with the interaction surface 1100, i.e. detecting said contact event, based on an acceleration of the input object 1090. As the user 111 moves the input object 1090 towards the interaction surface 1100 there will typically be an abrupt stop of the input object 1090 as it contacts the interaction surface 1100. The associated change in acceleration and/or velocity for such stop may thus be determined by the positioning unit 103, when tracking the motion of the input object 1090 over a duration of time. The virtual representation 1200 of the input motion on the interaction surface 1100, when the user 111 has the input object 1090 in contact with the interaction surface 1100, may thus be effectively determined. The positioning unit 103 may thus continue to track the motion of the input object 1090, when in contact with the interaction surface 1100, so the coordinates (xᵤ, yᵤ, zᵤ) of the tip 1094 are mapped to the XR environment coordinates and the associated virtual representation 1200 of the input motion is determined for the duration of the contact event, and displayed to the user 111.

The interaction system 100 may comprise a contact sensor 1300 in communication with the processing unit 104 and being configured to detect contact between the input object 1090 and the interaction surface 1100 as said contact event. This provides for accurately determining when the input motion occurs, i.e. when the coordinates (xᵤ, yᵤ, zᵤ) of the tip 1094 should be mapped as a virtual representation 1200 to the virtual space. The contact sensor 1300 may be connected to the interaction surface 1100 or a user input device 109. The contact sensor 1300 may be configured to detect contact by detecting change in force, i.e. a pressure sensor, or by detecting a change in electrical parameters, such as a capacitive sensor. The contact sensor 1300 may be an optical sensor. The contact sensor 1300 may be in wireless communication with the processing unit 104. The contact sensor 1300 may be connected to a light emitter (not shown), such as a LED, which is configured to emit light when contact is detected. The emitted light, i.e. this visual que, may then be detected by the image sensor device 106 which may already be tracking the input object 1090. The contact sensor 1300 may be configured to emit a sound which is detected for determining when the contact occurs.

The positioning unit 103 may be configured to associate the at least one stylus marker 1092, 1093, with a determined category of the input device 1090. E.g. the user 111 may have a plurality of input devices 1090, which could be distinguished by different visual characteristics, such as being differently colored etc. A first input device 1090 may be chosen as a dedicated brush, and assigned to a first category, while a second input device 1090 may be assigned as a narrow pencil, as a second category. The stylus marker 1092, 1093, of the first input device 1090 may thus have a different color than the stylus marker 1092, 1093, of the second input device 1090. The positioning unit 103 may be configured to distinguish between the first and second categories based on the different colors captured by the image data as detected by the image sensor device 106. The processing unit 104 may be configured to generate the virtual representation 1200 of the input motion based on said category, such as broad strokes of the first input device 1090 and narrow pencil lines of the second input device 1090. The stylus marker 1092, 1093, may distinguish the input device 1090 based on colors, patterns, active signaling, e.g. by light emitters, etc.

The interaction system 100 may comprise a second image sensor device 113, 1130, arranged on the interaction surface 1100, as schematically illustrated in FIG. 12b. The second image sensor device 113, 1130, may be configured to capture image data of the input object 1090, such as the user 111 and/or a user input device 109, and communicate the image data to the positioning unit 103. The positioning unit 103 is configured to the determine the position (xᵤ, yᵤ, zᵤ) of the input object 1090 relative to the interaction surface 1100 and the orientation of the input object 1090 relative to the interaction surface 1100 based on the captured image data. The second image sensor device 113, 1130, may comprise depth cameras for accurately determining the spatial positioning information. Inertia sensors may also track the movement of the input object 1090 for defined periods of time, such as the time between letters when writing a word. The positioning unit 103 may determine the orientation, position, or dynamics of the movement, such as the speed or acceleration, of the user input device 109 and/or the user 111 from the image data. The processing unit 104 may subsequently map such spatial position information to the XR environment coordinate system as described above for providing a precise representation of the user input device 109 and/or the user 111 in the XR space. The accuracy of the virtual representation 1200 of the input motion in the XR environment coordinate system may thus be improved so that user may experience a more direct connection between physical movements of e.g. user input device 109 and the resulting virtual presentation, which is critical for fine touch input gestures e.g. in high-resolution tasks. Such improved XR representation and tracking of the user input device 109 and/or the user 111 is also advantageous for avoiding disorientation of the user.

The processing unit 104 may thus be configured to map spatial position information associated with the determined orientation of the user 111 and/or a user input device 109 to the XR environment coordinate system, and the XR output device 102 may be configured to display the orientation of the user 111 and/or a user input device 109 in the virtual space.

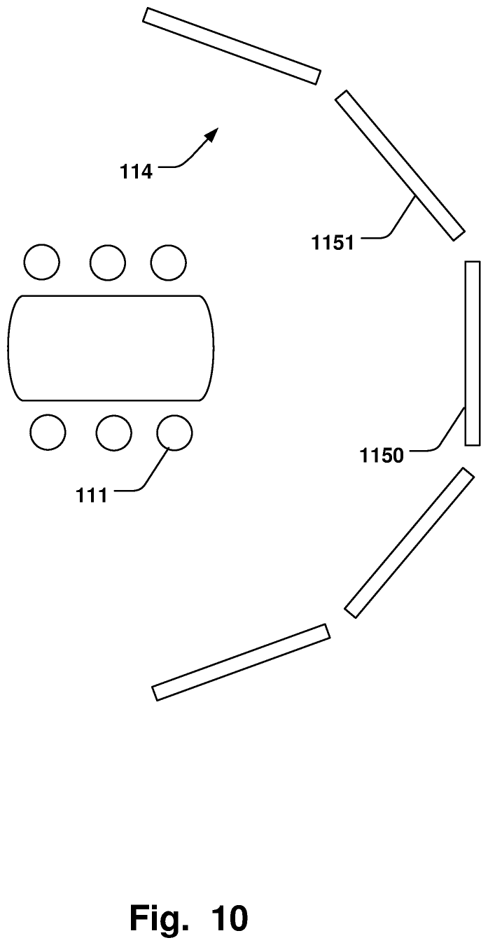

The XR output device 102 may be configured to display the interaction surface 1100 as a plurality of virtual user surfaces 114 in the virtual space, as schematically illustrated in FIG. 10. The processing unit 104 may be configured to associate at least a second virtual user surface 1151 of the plurality of virtual user surfaces 114 with a second set of XR environment coordinates in response to an input motion so that the XR output device 102 displays the second virtual user surface 1151 as being separated within the virtual space from a first virtual user surface 1150 associated with the interaction surface 1100 being engaged by the user 111. For example, it is conceivable that the XR output device 102 displays a presentation session in the XR space in one application, in which a plurality of virtual user surfaces 114 are displayed to a user 111 or a plurality of users. A user 111 may interact with a first virtual user surface 1150. The user may subsequently provide a dedicated input motion, such as a swipe gesture, to shift the first virtual user surface 1150 to a different location in the XR space (e.g. as denoted by reference 1151 in FIG. 10) and continue interaction with another virtual user surface in the XR space, but with the same physical interaction surface 1100. The user 111 may also use voice control to shift between the plurality of virtual user surfaces 114. Hence, a plurality of virtual user surfaces 114 may be arranged in the XR space for viewing and further interaction by the participating XR users. A user may then ‘activate’ any of the virtual user surfaces 114 for touch input, by again anchoring a first virtual user surface 1150 to the XR coordinates associated with the interaction surface 1100. The first virtual user surface 1150 aligned with the physical interaction surface 1100 may be highlighted e.g. with a different color in the XR space to facilitate the user orientation. The interaction system 100 thus provides for a highly dynamic interaction with the freedom to utilize the XR space while ensuring that all of the user's input is structured and retained, with high resolution and accuracy. It is conceivable that several interaction surfaces 1100 are connected over a communication network, where the interaction system 100 incorporates the interaction surfaces 1100 so that simultaneous input to the plurality of interaction surfaces 1100 can be provided and mapped to the XR space for simultaneous interaction and viewing by a plurality of users in a network. The input can be synchronized over the network, so that all users have up-to-date versions of the virtual user surfaces 114.

The interaction system 100 may comprise a touch sensitive apparatus 101 configured to receive touch input from the user 111 on the interaction surface 1100 as the input motion. The touch sensitive apparatus 101 may thus be connected to the interaction surface 1100 to detect touch input of the input object 1090 over the interaction surface 1100. Touch functionality may thus be added to the interaction surface 1100. FIG. 13 and FIG. 14c are schematic illustrations of the touch sensitive apparatus 101 being connected to the interaction surface 1100. The user's input motion on the interaction surface 1100 as discussed above may thus be provided by the touch input as detected by the touch sensitive apparatus 101. As before, the input motion is mapped to the XR environment coordinates. The interaction surface 1100 may thus be displayed as the virtual user surface 114, 1150, 1150, within the virtual space together with a virtual representation 1200 of the touch input as the input motion.

The XR user 111 may thus reliably interact with a high precision touch sensitive apparatus 101 in the physical reality whilst viewing the interaction in XR. Various input from the user's interaction with a XR environment may thus be captured with an increased accuracy. For example, touch input of fine details of a component for a machine presented in the XR space may be captured with the increased accuracy and low latency of the touch sensitive apparatus 101, that otherwise would not be resolved by typical spatial sensors in previous XR systems. Mapping the position of the touch sensitive apparatus 101, i.e. of the interaction surface 1100, to the XR environment provides further for an enhanced XR experience combining the freedom of customizing different XR environments to the user's tasks with the tactile interaction provided by the interaction surface 1100. Moreover, the simultaneous interaction with the touch sensitive apparatus 101 allows for a more viable handling of user input from a XR environment, such as the communication of a user's input to various related systems and applications. A realistic and more practical utilization of XR may thus be provided, across a range of applications and technical fields.

The touch sensitive apparatus 101 may thus detect the aforementioned contact event, i.e. when the user 111 place the input object 1090 in contact with the interaction surface 1100, and determine touch coordinates of the input object 1090 on the interaction surface 1100 to track the input object 1090 over the interaction surface 1100, i.e. touch surface. The virtual representation 1200 input motion may thus be reliably generated with high accuracy.

The positioning unit 103 may be configured to determine the position (xᵤ, yᵤ, zᵤ) of the input object 1090 based on the determined touch coordinates and the image data of the input object 1090, e.g. as captured by image sensor device 106. The interaction system 100 may thus utilize both the spatial position information provided by image data as captured by e.g. sensor device 106 of the user's XR output device 102, such as a XR headset, and the touch coordinates on the interaction surface 1100 as determined by the touch sensitive apparatus 101. This provides for determining the position of the input object (xᵤ, yᵤ, zᵤ) with high precision and an accurate mapping to the virtual space. A plurality of determined position pairs from the image data of the sensor device 106/XR headset and the determined touch positions can be aggregated over time to average out noise and positioning errors and arrive at a better relative positioning of the input object 1090 and the interaction surface 1100.

Further, when the input object 1090 is in contact with the interaction surface 1100/touch surface 1100, such as the tip 1094 of a user input device 109, the relationship between the position of the tip 1094 as determined from the image sensor 106 and the position as determined by the touch sensitive apparatus 101 may be used to refine the relative positioning, e.g. the position and/or rotation, to match the virtual user surface 114 and the physical interaction surface 1100.

The touch sensitive apparatus 101 may be configured to determine involuntary touch input by the user 111 on the interaction surface 1100 based on the spatial position information of the position of the input object 1090 relative the interaction surface 1100. E.g. the image data captured of the input object 109 by the image sensor device 106 may be utilized for estimating where the user 111 may place the palm of the hand, and adapt any palm rejection algorithm accordingly, such as by adjusting palm rejection threshold e.g. to avoid an overly active rejection in the area on the interaction surface 1100 where touch input is expected from the image data. A rough positioning of a user input device 109 and/or a user's hand may be done based on the image data, and be used as a starting point for palm-rejection algorithms in the touch sensing. The threshold for touches may be decreased in the region around the rough position of a tip 1094 of the user input device 109. A trace of the visual tip 1094 position, as detected by e.g. image sensor device 106, may be compared to a candidate trace position to provide better filtering of ghost touches. The position of the tip 1094 may be resolved from the position of the user's palm with greater accuracy. A determined or estimated position of the input device 1090 from the image data may be used instead of the touch position when parts of the user's touch input cannot be resolved in the touch sensitive apparatus 101. The determined or estimated position may be merged into the stream of candidate coordinates determined by the touch sensitive apparatus 101.

The touch sensitive apparatus 101 may be configured to display a calibration image 108 at (or at a defined distance to) the position of an input object 1090 such as a user input device 109 or a finger or hand of the user 111, on the interaction surface 1100 when the touch sensitive apparatus receives touch input from the input device 109, i.e. via the interaction surface 1100. The image sensor device 106 may be configured to capture image data comprising the calibration image 108 and the user input device 109 and/or the user 111. The positioning unit 103 may be configured to determine an orientation of the user input device 109 and/or the user 111 (such as one or more fingers, hand, or lower arm of the user) relative the interaction surface 1100 based on a projected image 110 of the user input device 109 and/or the user 111 on the calibration image 108. Thus, by observing which parts of the calibration image 108 being obscured by the user input device 109 and/or the user 111, the positioning unit 103 may determine the orientation, position, or dynamics of the movement, such as the speed or acceleration, of the user input device 109 and/or the user 111. Such spatial position information is then mapped to the XR environment coordinate system as described, which provides for a facilitated interaction with the touch sensitive apparatus 101, e.g. by displaying a virtual representation of the input object 1090 in the XR space, such as a virtual input device 1112 representing the user input device 109 and/or a model 1111 of the user 111 in the XR space (see e.g. FIG. 12a). This also allows for providing sufficient information to allow effective palm rejection, e.g. by identifying a stylus tip from the projected image and ignoring all other touches around that stylus tip position. As the user is usually looking at their hand when interacting with the touch panel, the calibration image 108 is advantageously displayed around the user input device 109 and/or the hand of the user 111.

The touch sensitive apparatus 101 may be configured to display the calibration image 108 tracking the position of the user input device 109, and/or the user 111, on the interaction surface 1100. The calibration image 108 may thus follow the position of the user input device 109, and/or the user 111, which may improve the detection of the above-mentioned spatial position information.

The positioning unit 103 may be configured to determine a calibration position of a user input device 109 in the XR environment coordinate system when touching at least one physical coordinate 112 on the touch sensitive apparatus 101 (i.e. on the touch panel 1010 thereof, which corresponds to the interaction surface 1100 discussed above). The processing unit 104 may be configured to map the position of the at least one physical coordinate to the XR environment coordinate system by registering the at least one physical coordinate to the calibration position when detecting the touch of the at least one physical coordinate 112. Thus, if the user has a tracked user input device 109, such as XR gloves or the like, the user may calibrate the position of the virtual user surface 114 in the XR space with a few touches on the touch panel 1010/interaction surface 1100. Each touch with the user input device 109 connects the respective physical coordinate at the touch site of the touch panel 1010/interaction surface 1100 with the coordinate of the user input device 109 in the XR environment coordinate system, when at the same point in time.

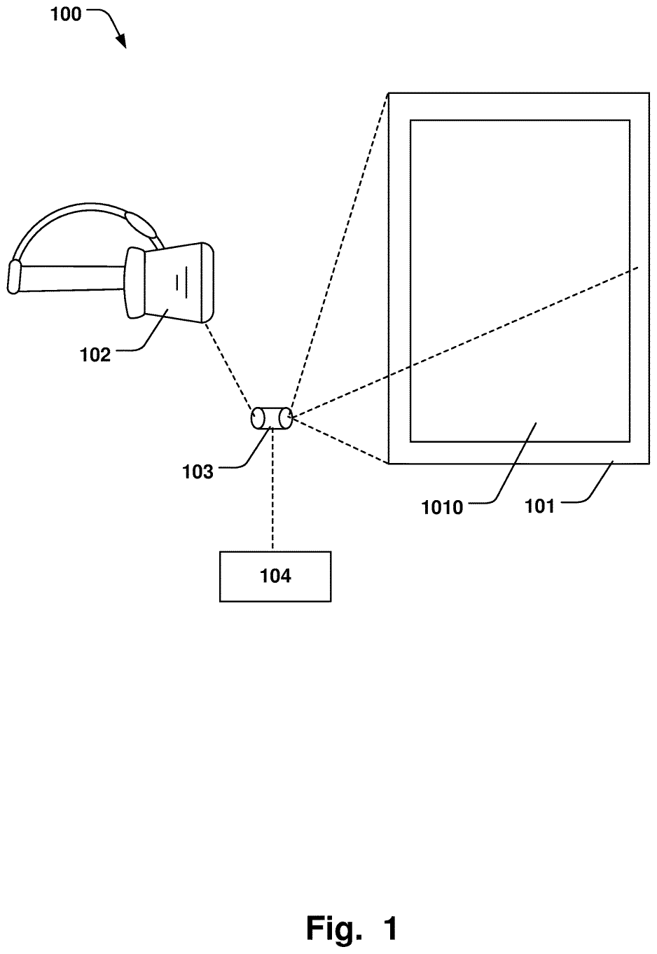

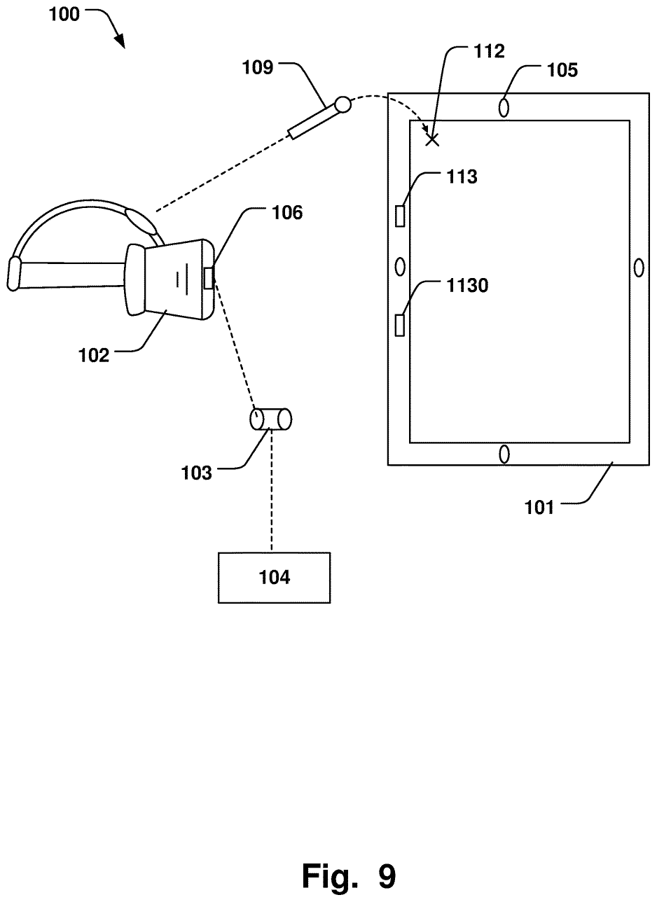

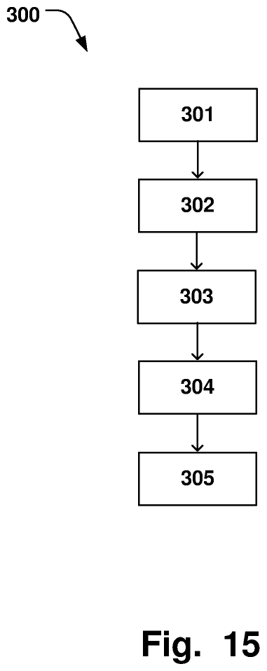

FIG. 15 illustrates a flow chart of a method 300 in an interaction system 100. The order in which the steps of the method 300 are described and illustrated should not be construed as limiting and it is conceivable that the steps can be performed in varying order. The interaction system 100 has an interaction surface 1100 to be engaged by a user 111 by providing an input object 1090 in contact with the interaction surface 1100 for an input motion thereon, and an XR output device 102 configured to display a model 1111 of the user 111 in a XR environment coordinate system (vₓ, v_{y}, v_{z}) within a virtual space. The method 300 comprises providing 301 spatial position information of the position (x, y, z) of the interaction surface 1100 relative to the user 111 and of the position (xᵤ, yᵤ, zᵤ) of the input object 1090 relative to the interaction surface 1100. The contact with the interaction surface 1100 is detected as a contact event. The method 300 comprises mapping 302 the spatial position information of the interaction surface 1100 and the input object 1090 to the XR environment coordinate system. The method 300 comprises generating 303 a virtual representation 1200 of the input motion in the XR environment coordinate system while the contact event is detected. The method 300 comprises communicating 304 a set of XR environment coordinates of the interaction surface 1100 and of the virtual representation 1200 of the input motion to the XR output device 102 so that the interaction surface 1100 is displayed 305 as a virtual user surface 114, 1150, 1150, within the virtual space together with the virtual representation 1200 of the input motion by the input object 1090. The method 300 thus provides for the advantageous benefits as described above in relation to the interaction system 100 and FIGS. 1-14.

A computer program product is provided comprising instructions which, when the program is executed by a computer, cause the computer to carry out the steps of the method 300.

FIG. 1 is a schematic illustration of an interaction system 100 comprising a touch sensitive apparatus 101 configured to receive touch input from a user 111, and a XR output device 102 configured to display a position of the user 111 and a virtual representation of the touch input (see e.g. schematic illustration denoted by reference number 1200 in FIG. 12a) in a XR environment coordinate system within a virtual space. The touch sensitive apparatus 101 may be configured to receive input using e.g., one or more fingers, a pointer or stylus etc. on a touch panel 1010 of the touch sensitive apparatus 101. The touch panel 1010 may thus correspond to the interaction surface 1100 described above in relation to FIGS. 12-14 . The XR output device 102 may be configured to be wearable by the user 111 and may thus comprise a XR headset. The XR output device 102 presents a virtual space to the user 111, as well as a virtual representation 1200 of the touch input, when the user provides touch input to the touch sensitive apparatus 101. A model 1111 of the user 111, i.e. a virtual representation of the user 111, such as one or more fingers, and/or a virtual input device 1112 representing a pointer or a stylus 109 may be presented in the XR output device 102 to facilitate orientation in the virtual space (see example in FIG. 12a). The objects presented in the virtual space, such as the user, the virtual representation of the touch input, or any other (interactable) XR objects have thus determined coordinates in the XR environment coordinate system, for visualization via the XR output device 102. The XR coordinates may be determined by sensor devices configured to detect the location and movements of these objects. Further, the touch-based XR interaction system 100 comprises a positioning unit 103 configured to provide spatial position information of the position of the touch sensitive apparatus 101 relative to the user, and a processing unit 104 configured to map the spatial position information of the touch sensitive apparatus 101 to the XR environment coordinate system. The processing unit 104 is configured to communicate a set of XR environment coordinates of the touch sensitive apparatus 101 to the XR output device 102 so that the touch sensitive apparatus 101 is displayed within the virtual space together with the virtual representation of the touch input. The XR user may thus reliably interact with a high precision touch sensitive apparatus 101 in the physical reality whilst viewing the interaction in XR. Various input from the user's interaction with a XR environment may thus be captured with an increased accuracy. For example, touch input of fine details of a component for a machine presented in the XR space may be captured with the increased accuracy and low latency of the touch sensitive apparatus 101, that otherwise would not be resolved by typical spatial sensors in previous XR systems. Mapping the position of the touch sensitive apparatus 101 to the XR environment provides further for an enhanced XR experience combining the freedom of customizing different XR environments to the user's tasks with the tactile interaction provided by the touch sensitive apparatus 101. Moreover, the simultaneous interaction with the touch sensitive apparatus 101 allows for a more viable handling of user input from a XR environment, such as the communication of a user's input to various related systems and applications. A realistic and more practical utilization of XR may thus be provided, across a range of applications and technical fields.

There are numerous known techniques for providing touch sensitivity to the touch panel 1010, e.g. by using cameras to capture light scattered off the point(s) of touch on the panel, by using cameras to directly observe the objects interacting with the panel, by incorporating resistive wire grids, capacitive sensors, strain gauges, etc. into the panel. In one category of touch-sensitive panels known as ‘above surface optical touch systems’, a plurality of optical emitters and optical receivers are arranged around the periphery of the touch surface of the panel 1010 to create a grid of intersecting light paths (otherwise known as detection lines) above the touch surface. Each light path extends between a respective emitter/receiver pair. An object that touches the touch surface will block or attenuate some of the light paths. Based on the identity of the receivers detecting a blocked light path, a processor can determine the location of the intercept between the blocked light paths.

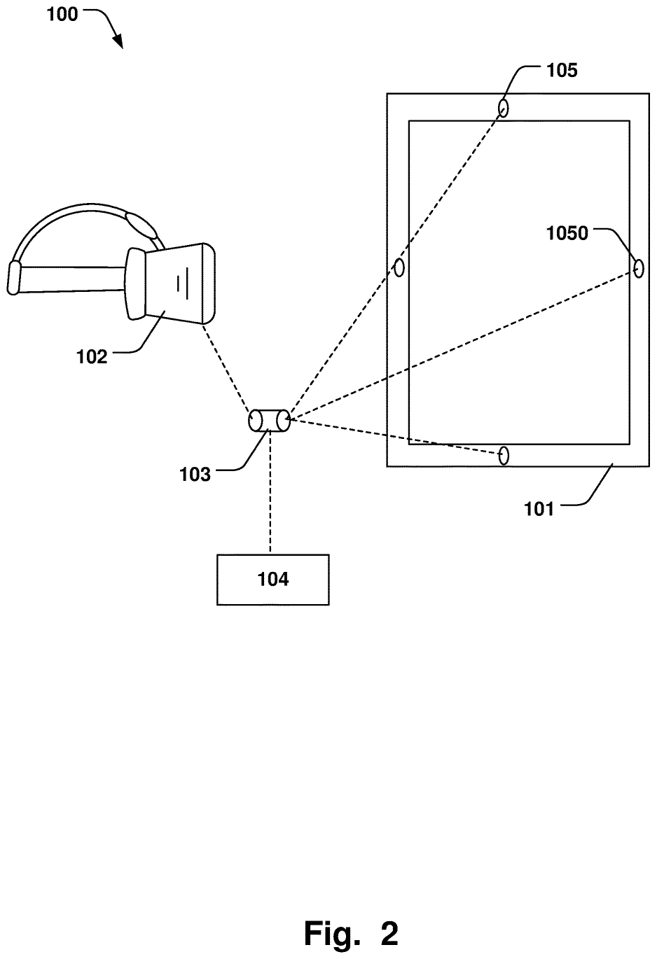

The interaction system 100 may comprise at least one spatial marker 105, 1050, arranged on the touch sensitive apparatus 101, as schematically illustrated in FIG. 2. The positioning unit 103 may be configured to track the at least one spatial marker 105, 1050, to determine an associated position of the touch sensitive apparatus 101 relative to the user. The at least one spatial marker 105, 1050, may comprise IR markers such as IR light sources, or any other marker configured for allowing tracking by the positioning unit 103, such as markers of different shapes and configurations being physically provided on parts of the touch sensitive apparatus 101 and/or displayed on the touch panel 1010 thereof. The touch panel 1010 may be arranged over a display configured to display the at least one spatial marker 105, 1050. The touch panel 1010 may thus be light transmissive. Accurate mapping of the obtained spatial position information to the XR environment coordinate system may then be provided. FIG. 2 illustrates first and second spatial markers 105, 1050, but it is conceivable that the number of spatial markers may be varied to provide for an optimized position detection.

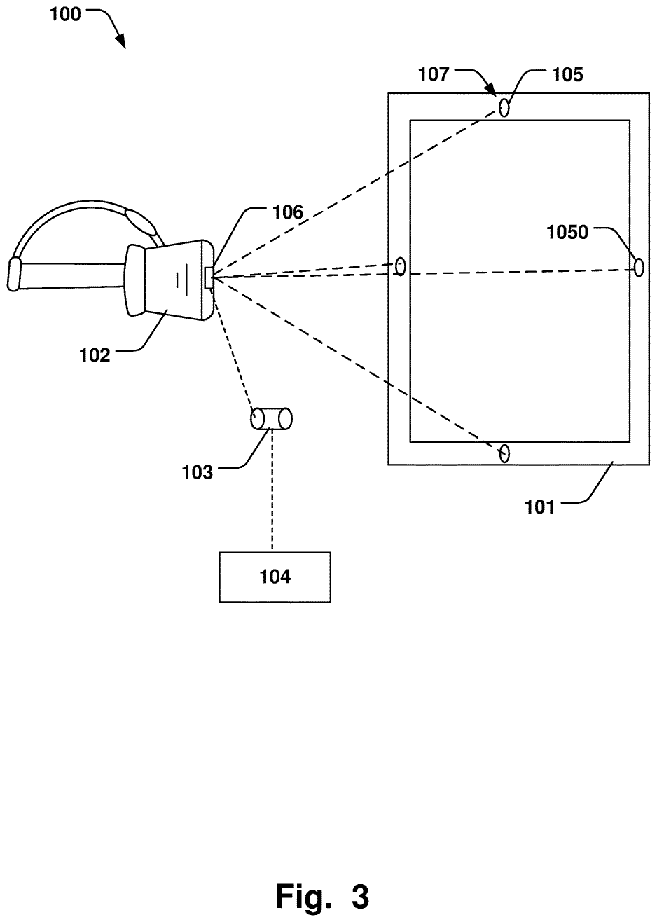

The interaction system 100, such as a touch-based XR interaction system 100, may comprise an image sensor device 106 configured to be wearable by the user, as schematically illustrated in FIGS. 3-8. The image sensor device 106 may be configured to capture image data 107, 1070, 1071, 1072, associated with the position of the touch sensitive apparatus 101 and communicate the image data to the positioning unit 103, which is configured to determine the position of the touch sensitive apparatus 101 relative to the user based on the captured image data, such as by a triangulation process of the obtained image data. Since the image sensor device 106 may be arranged at the position of the user, i.e. by being wearable, the relative position between the user and the touch sensitive apparatus 101 may be accurately determined. This provides for accurately determining the XR environment coordinates of the touch sensitive apparatus 101 and a precise positioning the touch sensitive apparatus in the virtual space. Such precise positioning in the virtual space facilitates the interaction with the touch sensitive apparatus 101 when the user is immersed in the XR experience, since the virtual representation of the touch sensitive apparatus 101 may be precisely aligned with the physical touch sensitive apparatus 101. The virtual representation of the touch sensitive apparatus 101 is referred to as a virtual user surface 114, 1150, 1151, in examples of the disclosure. The touch-based XR interaction system 100 thus enables high-resolution input and for more complex tasks to be carried out by the user in the XR space.

The image sensor device 106 may be configured to capture image data 107 of the at least one spatial marker 105, 1050, and communicate the image data to the positioning unit 103, which is configured to determine the position of the touch sensitive apparatus 101 relative to the user based on the captured image data. FIG. 3 illustrates an example where the image sensor device 106 locates the position of the touch sensitive apparatus 101 based on spatial markers 105, 1050. The processing unit 104 may then accurately map the retrieved spatial position information to the XR environment coordinate system.

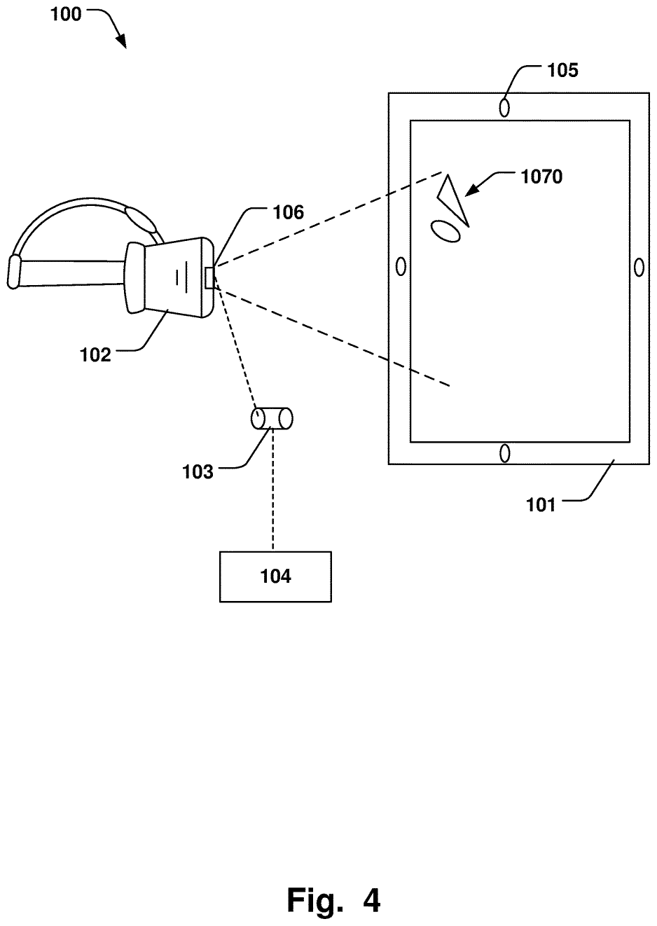

The image sensor device 106 may be configured to capture image data 1070 displayed by the touch sensitive apparatus 101 and communicate the image data to the positioning unit 103, as schematically illustrated in FIG. 4. The image data 1070 displayed by the touch sensitive apparatus 101 may comprise objects of varying shapes and configurations that allow for a calibration of the position of the touch sensitive apparatus 101 in the XR environment coordinate system. A flexible and highly optimizable calibration may thus be provided since the displayed image data may be varied for different conditions and applications.

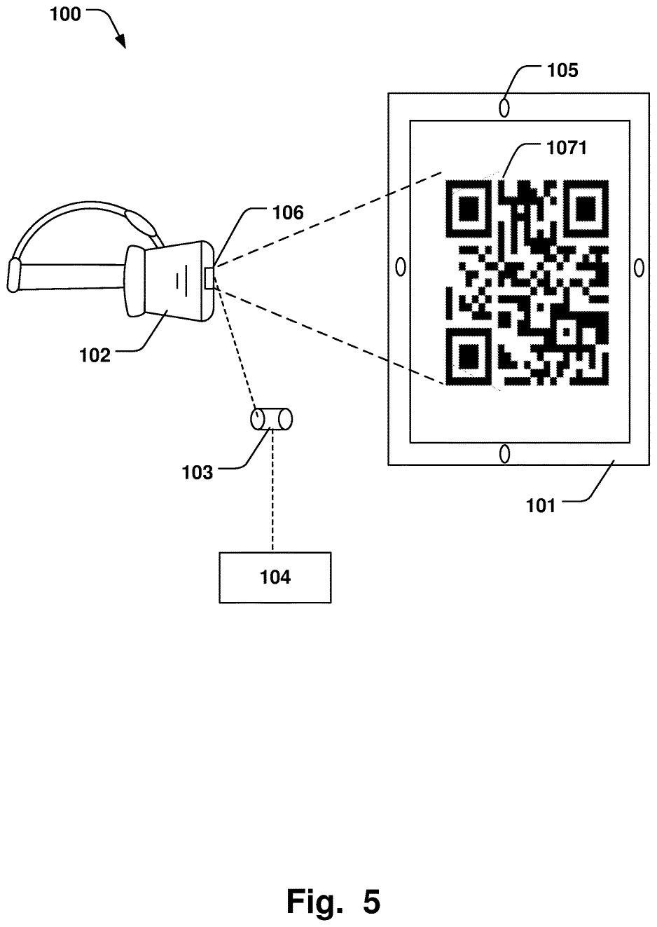

The touch sensitive apparatus 101 may be configured to display image data comprising at least one orientation tag 1071, as schematically illustrated in FIG. 5. The positioning unit 103 may be configured to track the position of the at least one orientation tag 1071 to determine an associated position of the touch sensitive apparatus 101 relative to the user. The number of orientation tags 1071 displayed and the configurations thereof may vary to provide for a precise positioning procedure and a XR environment which is accurately anchored to the physical reality, i.e. the touch sensitive apparatus 101.

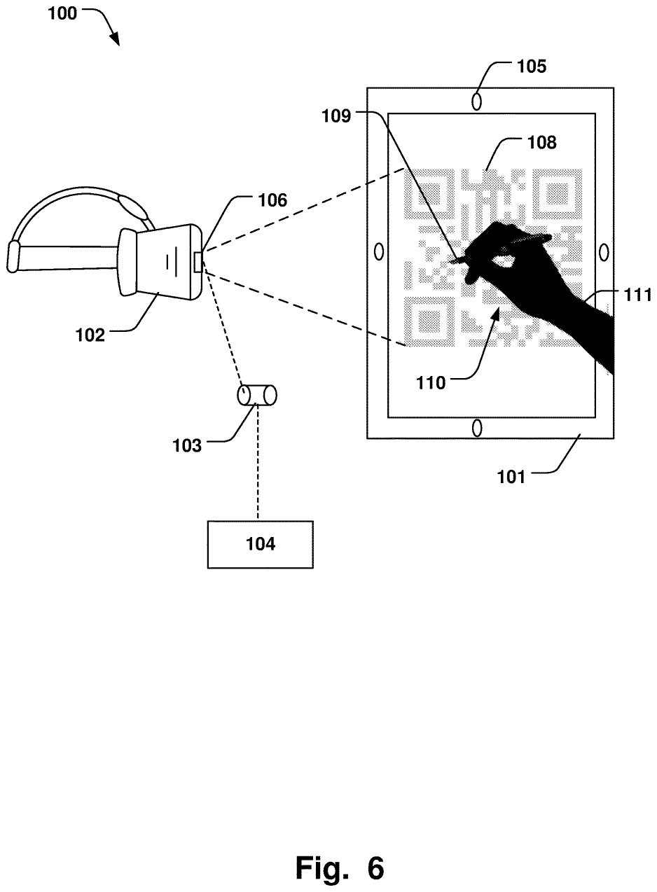

The touch sensitive apparatus 101 may be configured to display a calibration image 108 at (or at a defined distance to) the position of an input object 1090 such as a user input device 109 or a finger or hand of the user 111, on the touch sensitive apparatus 101 when the touch sensitive apparatus receives touch input from the input device 109, as schematically illustrated in FIG. 6. The image sensor device 106 may be configured to capture image data comprising the calibration image 108 and the user input device 109 and/or the user 111. The positioning unit 103 may be configured to determine an orientation of the user input device 109 and/or the user 111 (such as one or more fingers, hand, or lower arm of the user) relative the touch sensitive apparatus 101 based on a projected image 110 of the user input device 109 and/or the user 111 on the calibration image 108. Thus, by observing which parts of the calibration image 108 being obscured by the user input device 109 and/or the user 111, the positioning unit 103 may determine the orientation, position, or dynamics of the movement, such as the speed or acceleration, of the user input device 109 and/or the user 111. Such spatial position information is then mapped to the XR environment coordinate system as described, which provides for a facilitated interaction with the touch sensitive apparatus 101, e.g. by displaying a virtual representation of the input object 1090 in the XR space, such as a virtual input device 1112 representing the user input device 109 and/or a model 1111 of the user 111 in the XR space (see e.g. FIG. 12a). This also allows for providing sufficient information to allow effective palm rejection, e.g. by identifying a stylus tip from the projected image and ignoring all other touches around that stylus tip position. As the user is usually looking at their hand when interacting with the touch panel, the calibration image 108 is advantageously displayed around the user input device 109 and/or the hand of the user 111.

The touch sensitive apparatus 101 may be configured to display the calibration image 108 tracking the position of the user input device 109, and/or the user 111, on the touch sensitive apparatus 101. The calibration image 108 may thus follow the position of the user input device 109, and/or the user 111, on the touch sensitive apparatus 101, which may improve the detection of the above-mentioned spatial position information.

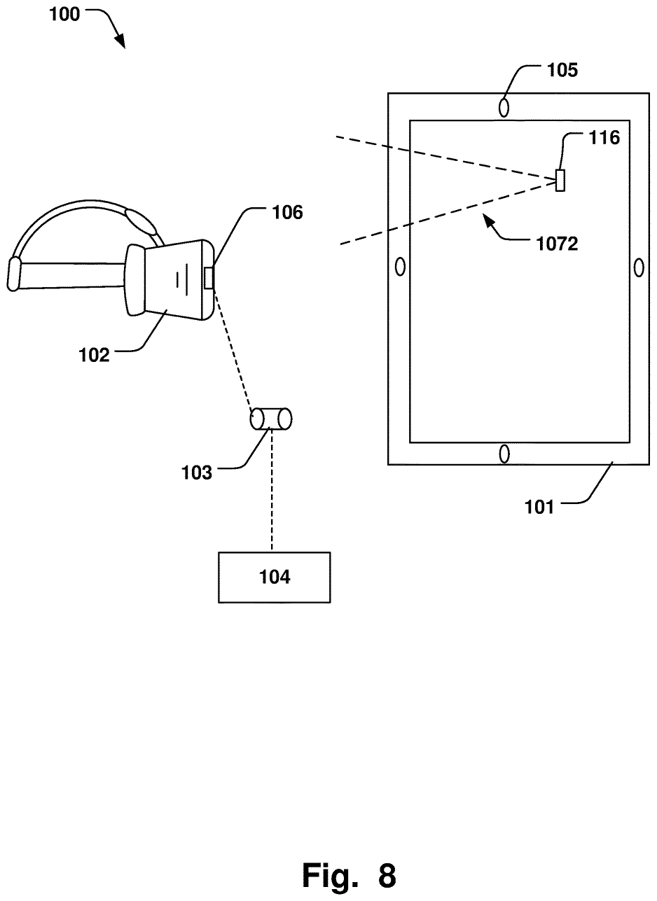

The interaction system 100 may comprise a light emitter 116 arranged at a determined spatial position relative to the touch sensitive apparatus 101, as schematically illustrated in FIG. 8. The image sensor device 106 may be configured to capture image data 1072 of light emitted by the light emitter and communicate the image data to the positioning unit 103, which is configured to determine the position of the touch sensitive apparatus 101 relative to the user based on the captured image data. The light may be IR light or light of any other wavelength suitable for detection by the image sensor device 106.

The image sensor device 106 may be arranged at the XR output device 102, as schematically illustrated in FIGS. 3-8. It is conceivable however that the image sensor device 106 may be displaced from the XR output device 102 but at a predetermined distance from the touch sensitive apparatus 101 and communicating with the positioning unit 103, so that the image data 107-1072 may be received by the positioning unit 103.

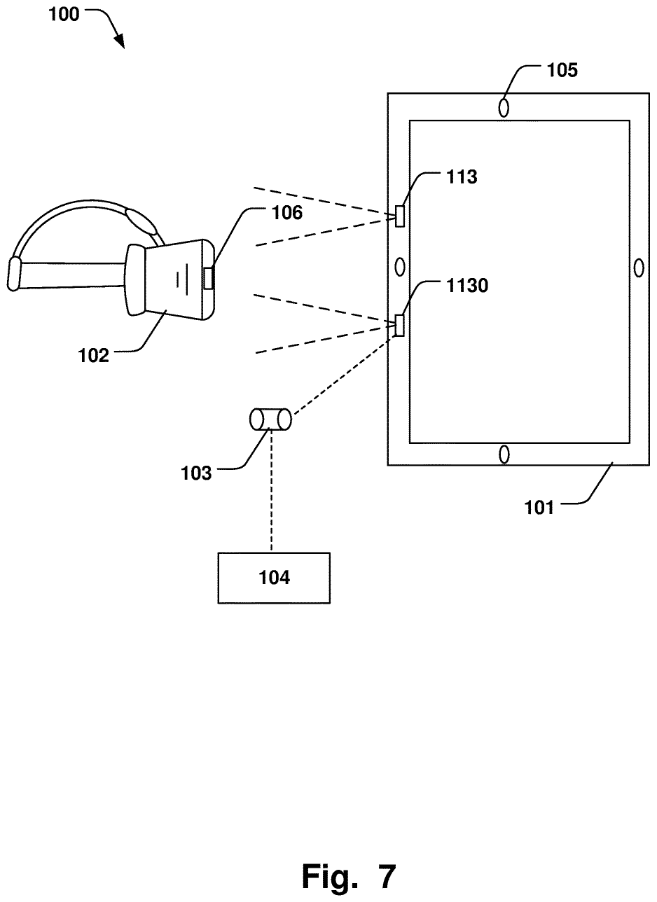

The interaction system 100 may comprise a second image sensor device 113, 1130, arranged on the touch sensitive apparatus 101, as schematically illustrated in FIG. 7. The second image sensor device 113, 1130, may be configured to capture image data of the user 111 and/or a user input device 109 and communicate the image data to the positioning unit 103, which is configured to determine an orientation of the user 111 and/or a user input device 109 relative to the touch sensitive apparatus 101 based on the captured image data. The second image sensor device 113, 1130, may comprise depth cameras for accurately determining the spatial positioning information. Inertia sensors may also track the movement of the user input device 109 for defined periods of time, such as the time between letters when writing a word. The positioning unit 103 may determine the orientation, position, or dynamics of the movement, such as the speed or acceleration, of the user input device 109 and/or the user 111 from the image data. The processing unit 104 may subsequently map such spatial position information to the XR environment coordinate system as described above for providing a precise representation of the user input device 109 and/or the user 111 in the XR space. The accuracy of the virtual representation of the touch input in the XR environment coordinate system may thus be improved so that user may experience a more direct connection between physical movements of e.g. input device 109 and the resulting virtual presentation, which is critical for fine touch input gestures e.g. in high-resolution tasks. Such improved XR representation and tracking of the user input device 109 and/or the user 111 is also advantageous for avoiding disorientation of the user.

The processing unit 104 may thus be configured to map spatial position information associated with the determined orientation of the user 111 and/or a user input device 109 to the XR environment coordinate system, and the XR output device 102 may be configured to display the orientation of the user 111 and/or a user input device 109 in the virtual space.

The positioning unit 103 may be configured to determine a calibration position of a user input device 109 in the XR environment coordinate system when touching at least one physical coordinate 112 on the touch sensitive apparatus 101 (i.e. on the touch panel 1010 thereof). The processing unit 104 may be configured to map the position of the at least one physical coordinate to the XR environment coordinate system by registering the at least one physical coordinate to the calibration position when detecting the touch of the at least one physical coordinate 112. Thus, if the user has a tracked user input device 109, such as XR gloves or the like, the user may calibrate the position of the touch sensitive apparatus 101 in the XR space with a few touches on the touch panel 1010. Each touch with the user input device 109 connects the respective physical coordinate at the touch site of the touch panel 1010 with the coordinate of the user input device 109 in the XR environment coordinate system, when at the same point in time.

The XR output device 102 may be configured to display the touch sensitive apparatus as a plurality of virtual user surfaces 114 in the virtual space, as schematically illustrated in FIG. 10. The processing unit 104 may be configured to associate at least a second virtual user surface 1151 of the plurality of virtual user surfaces 114 with a second set of XR environment coordinates in response to a user input so that the XR output device 102 displays the second virtual user surface 1151 as being separated within the virtual space from a first virtual user surface 1150 representing the touch sensitive apparatus receiving touch input. For example, it is conceivable that the XR output device 102 displays a presentation session in the XR space in one application, in which a plurality of virtual user surfaces 114 is displayed to a user 111 or a plurality of users. A user 111 may interact with a first virtual user surface 1150. The user may subsequently provide a dedicated touch input, such as a swipe gesture, to shift the first virtual user surface 1150 to a different location in the XR space (e.g. as denoted by reference 1151 in FIG. 10) and continue interaction with another virtual user surface in the XR space, but with the same physical touch sensitive apparatus 101. The user 111 may also use voice control to shift between the plurality of virtual user surfaces 114. Hence, a plurality of virtual user surfaces 114 may be arranged in the XR space for viewing and further interaction by the participating XR users. A user may then ‘activate’ any of the virtual user surfaces 114 for touch input, by again anchoring a first virtual user surface 1150 to the XR coordinates represented by the touch sensitive apparatus 101. The first virtual user surface 1150 aligned with the physical touch sensitive apparatus 101 may be highlighted e.g. with a different color in the XR space to facilitate the user orientation. The touch-based XR interaction system 100 thus provides for a highly dynamic interaction with the freedom to utilize the XR space while ensuring that all of the user's input is structured and retained, with high resolution and accuracy. It is conceivable that several touch sensitive apparatuses 101 are connected over a communication network, where the touch-based XR interaction system 100 incorporates the touch sensitive apparatuses 101 so that simultaneous input to the plurality of touch panels 1010 can be provided and mapped to the XR space for simultaneous interaction and viewing by a plurality of users in a network.

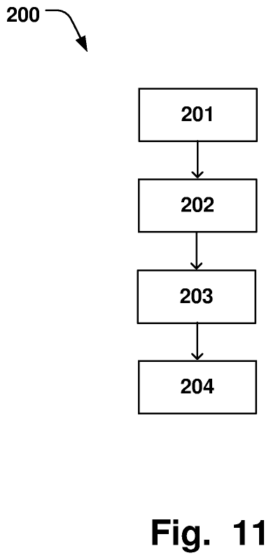

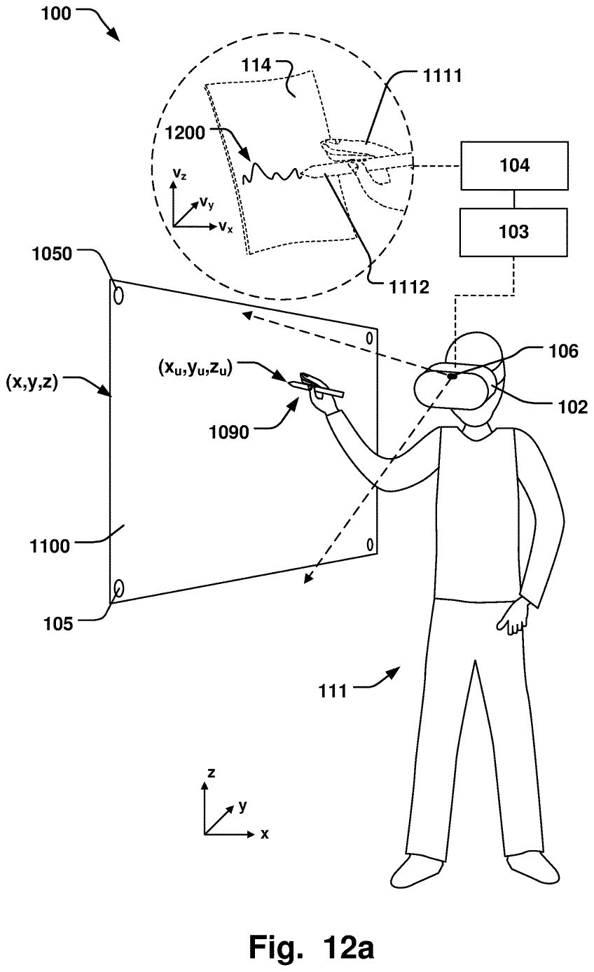

FIG. 11 illustrates a flow chart of a method 200 in an interaction system 100. The order in which the steps of the method 200 are described and illustrated should not be construed as limiting and it is conceivable that the steps can be performed in varying order. The interaction system 100 has a touch sensitive apparatus 101 configured to receive touch input from a user, and a XR output device 102 configured to display a position of the user and a virtual representation of the touch input in a XR environment coordinate system within a virtual space. The method 200 comprises providing 201 spatial information of the position of the touch sensitive apparatus 101 relative to the user, and mapping 202 the spatial position information of the touch sensitive apparatus 101 to the XR environment coordinate system. The method 200 comprises communicating 203 a set of XR environment coordinates of the touch sensitive apparatus to the XR output device 102 so that the touch sensitive apparatus 101 is displayed 204 within the virtual space together with the virtual representation of the touch input. The method 200 thus provides for the advantageous benefits as described above in relation to the interaction system 100 and FIGS. 1-10, or FIGS. 13, 14c.

A computer program product is provided comprising instructions which, when the program is executed by a computer, cause the computer to carry out the steps of the method 200.

The present disclosure has been described above with reference to specific examples. However, other examples than the above described are equally possible within the scope of the disclosure. The different features and steps of the disclosure may be combined in other combinations than those described. The scope of the disclosure is only limited by the appended patent claims.

More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

1. An interaction system comprising
an interaction surface to be engaged by a user by providing an input object in contact with the interaction surface for an input motion thereon,
a XR output device configured to display a model of the user in a XR environment coordinate system within a virtual space,
a positioning unit configured to
provide spatial position information of the position of the interaction surface relative to the user, and of the position of the input object relative to the interaction surface, wherein the contact with the interaction surface is detected as a contact event,
a processing unit in communication with the positioning unit and being configured to
map the spatial position information of the interaction surface and the input object to the XR environment coordinate system,
generate a virtual representation of the input motion in the XR environment coordinate system while the contact event is detected, and
communicate a set of XR environment coordinates of the interaction surface and of the virtual representation of the input motion to the XR output device so that the interaction surface is displayed as a virtual user surface within the virtual space together with the virtual representation of the input motion by the input object.

2. The interaction system according to claim 1, comprising at least one spatial marker arranged on the interaction surface, wherein the positioning unit is configured to track the at least one spatial marker to determine an associated position of the interaction surface relative to the user.

3. The interaction system according to claim 1, comprising
an image sensor device configured to be wearable by the user, and wherein the image sensor device is configured to capture image data associated with the position of the interaction surface and communicate the image data to the positioning unit, wherein the positioning unit is configured to determine the position of the interaction surface relative to the user based on the captured image data.

4. The interaction system according to claim 2, wherein the image sensor device is configured to capture image data of the at least one spatial marker and communicate the image data to the positioning unit, wherein the positioning unit is configured to determine the position of the interaction surface relative to the user based on the captured image data.

5. The interaction system according to claim 3, wherein the interaction surface is configured to be arranged over a display, wherein the image sensor device is configured to capture image data displayed by the display and communicate the image data to the positioning unit, wherein the positioning unit is configured to determine the position of the interaction surface relative to the user based on the captured image data.

6. The interaction system according to claim 5, wherein the display is configured to display image data comprising at least one orientation tag, and wherein the positioning unit is configured to track the position of the at least one orientation tag to determine an associated position of the interaction surface relative to the user.

7. The interaction system according to claim 3, comprising a light emitter arranged at a determined spatial position relative to the interaction surface, and wherein the image sensor device is configured to capture image data of light emitted by the light emitter and communicate the image data to the positioning unit, wherein the positioning unit is configured to determine the position of the interaction surface relative to the user based on the captured image data.

8. (canceled)

9. The interaction system according to claim 3, wherein the image sensor device is configured to capture image data of the input object and communicate said image data to the positioning unit, wherein the positioning unit is configured to determine the position of the input object relative to the interaction surface and an orientation of the input object relative to the interaction surface based on said captured image data.

10. The interaction system according to claim 9, wherein the positioning unit is configured to continuously determine the position of the input object relative to the interaction surface to track a motion of the input object over a duration of time, and to calculate a velocity and/or an acceleration of the input object.

11. The interaction system according to claim 9, wherein the input object comprises a user input device, such as a stylus, wherein the user input device comprises at least one stylus marker, wherein the positioning unit is configured to track the at least one stylus marker to determine an associated position of the user input device relative to the interaction surface.

12. The interaction system according to claim 11, wherein the user input device comprises first and second stylus markers at opposite ends of the user input device.

13. The interaction system according to claim 10, wherein the positioning unit is configured to detect said contact event based on an acceleration of the input object.

14. (canceled)

15. The interaction system according to claim 11, wherein the positioning unit is configured to associate the at least one stylus marker with a determined category of the input device, wherein the processing unit is configured to generate the virtual representation of the input motion based on said category.

16. The interaction system according to claim 1, comprising a second image sensor device arranged on the interaction surface, wherein the second image sensor device is configured to capture image data of the input object and communicate said image data to the positioning unit, wherein the positioning unit is configured to determine the position (xᵤ, yᵤ, zᵤ) of the input object relative to the interaction surface and an orientation of the input object relative to the interaction surface based on said captured image data.

17. The interaction system according to claim 9, wherein the processing unit is configured to map spatial position information associated with the determined orientation of the input object to the XR environment coordinate system, and wherein the XR output device is configured to display the orientation of the input object in the virtual space.

18. The interaction system according to claim 1, wherein the XR output device is configured to display the interaction surface as a plurality of virtual user surfaces in the virtual space, wherein the processing unit is configured to associate at least a second virtual user surface of the plurality of virtual user surfaces with a second set of XR environment coordinates in response to an input motion so that the XR output device displays the second virtual user surface as being separated within the virtual space from a first virtual user surface associated with the interaction surface engaged by the user.

19. The interaction system according to claim 1, comprising a touch sensitive apparatus configured to receive touch input from the user on the interaction surface as the input motion, whereby the interaction surface is displayed as the virtual user surface within the virtual space together with the virtual representation of the touch input as the input motion.

20. (canceled)

21. The interaction system according to claim 9, wherein the positioning unit is configured to determine the position of the input object based on the touch coordinates and the image data of the input object.

22. The interaction system according to claim 19, wherein the touch sensitive apparatus is configured to determine involuntary touch input by the user on the interaction surface based on the spatial position information of the position of the input object.

23. (canceled)

24. (canceled)

25. The interaction system according to claim 19, wherein the positioning unit is configured to determine a calibration position of the input object in the XR environment coordinate system when touching at least one physical coordinate on the interaction surface, whereby the processing unit is configured to map the position of the at least one physical coordinate to the XR environment coordinate system by registering the at least one physical coordinate to the calibration position when detecting the touch of the at least one physical coordinate.

26. A method in an interaction system having an interaction surface to be engaged by a user by providing an input object in contact with the interaction surface for an input motion thereon, and an XR output device configured to display a model of the user in a XR environment coordinate system within a virtual space, the method comprising
providing spatial position information of the position of the interaction surface relative to the user and of the position of the input object relative to the interaction surface, wherein the contact with the interaction surface is detected as a contact event,
mapping the spatial position information of the interaction surface and the input object to the XR environment coordinate system,
generating a virtual representation of the input motion in the XR environment coordinate system while the contact event is detected,
communicating a set of XR environment coordinates of the interaction surface and of the virtual representation of the input motion to the XR output device so that the interaction surface is displayed as a virtual user surface within the virtual space together with the virtual representation of the input motion by the input object.

27. An interaction system comprising
a touch sensitive apparatus configured to receive touch input from a user,
a XR output device configured to display a position of the user and a virtual representation of the touch input in a XR environment coordinate system within a virtual space,
a positioning unit configured to provide spatial position information of the position of the touch sensitive apparatus relative to the user,
a processing unit configured to map the spatial position information of the touch sensitive apparatus to the XR environment coordinate system,
whereby the processing unit is configured to communicate a set of XR environment coordinates of the touch sensitive apparatus to the XR output device so that the touch sensitive apparatus is displayed within the virtual space together with the virtual representation of the touch input.

28. (canceled)

30. (canceled)

31. (canceled)

32. (canceled)

33. (canceled)

34. (canceled)

35. (canceled)

36. (canceled)

37. The interaction system according to claim 27, comprising a second image sensor device arranged on the touch sensitive apparatus, wherein the second image sensor device is configured to capture image data of the user and/or a user input device and communicate the image data to the positioning unit, wherein the positioning unit is configured to determine an orientation of the user and/or a user input device relative to the touch sensitive apparatus based on the captured image data.

38. (canceled)

39. The interaction system according to claim 27, wherein the positioning unit is configured to determine a calibration position of a user input device in the XR environment coordinate system when touching at least one physical coordinate on the touch sensitive apparatus, whereby the processing unit is configured to map the position of the at least one physical coordinate to the XR environment coordinate system by registering the at least one physical coordinate to the calibration position when detecting the touch of the at least one physical coordinate.

40. The interaction system according to claim 27, wherein the XR output device (102) is configured to display the touch sensitive apparatus as a plurality of virtual representations thereof in the virtual space, wherein the processing unit is configured to associate at least a second virtual representation of the plurality of virtual representations with a second set of XR environment coordinates in response to a user input so that the XR output device displays the second virtual representation as being separated within the virtual space from a first virtual representation of the touch sensitive apparatus receiving touch input.

41. (canceled)

42. (canceled)

43. (canceled)
